(19) United States
(12) Patent Application Publication
(10) Pub. No.: US 2025/0320071 A1
(43) Pub. Date: Oct. 16, 2025

(54) RECEIVER DEVICE WITH INTERNAL DAMPING

(71) Applicant: DYNAMIC AIR LTDA, Sao Paulo (BR)

(72) Inventors: Horacio N. Paez, Sao Paulo (BR); Gregory J. Steele, Saint Paul, MN (US)

(73) Assignee: DYNAMIC AIR LTDA, Sao Paulo (BR)

(21) Appl. No.: 19/077,942

(22) Filed: Mar. 12, 2025

(30) Foreign Application Priority Data
Mar. 19, 2024 (BR) 1020240053923

(51) Int. Cl. B65G 53/58; B65G 53/40

(52) U.S. Cl. CPC B65G 53/58; B65G 53/40

(57) ABSTRACT

The present invention relates to a receiver device comprising: a housing; an outlet; at least one inlet configured to be coupled to at least one pipeline of at least one pneumatic conveyance system; and at least one flexible barrier arranged inside the housing, configured to reduce the velocity of particles of material arriving transported by the at least one pneumatic transport system, from the at least one inlet to the outlet.

### TECHNICAL FIELD

The present invention relates to the field of pneumatic material conveyance. In particular, the present invention relates to a receiver device provided with internal damping to reduce the velocity of particles arriving at the receiver device.

### BACKGROUND ART

The technology of pneumatic conveyance is widely known in the prior art. It is based on the use of an air or other gas flow to move material from one location to another. Pneumatic conveyance is widely used in various industries, such as the food, pharmaceutical, and chemical industries, as it is an efficient, safe, and clean means of transport.

Pneumatic conveyance generally involves a system composed of a network of pipelines, valves, air pumps or compressors, tanks, and pneumatic conveyors. The materials to be transported are either suctioned or pushed through a gas stream inside the pipelines. Depending on the application, pneumatic conveyance can be carried out in two main ways: dilute phase or dense phase.

However, pneumatic conveyance also presents challenges. One of them, depending on the application, is ensuring the integrity of the material being transported at its final destination. The impact between particles of material or between particles of material and parts of the pneumatic conveyance system can lead to degradation of the transported material. This can result in a loss of value of the material, a reduction in effectiveness of the material (for example, a catalyst material may have its catalytic effect diminished if degraded), and dust generation, which can be particularly problematic when transporting toxic or explosive materials.

The precise regulation of gas flow throughout the pneumatic system is a well-known method to reduce this problem. However, alternative or additional solutions are always sought.

### SUMMARY OF THE INVENTION

The present invention relates to a receiver device comprising: a housing; an outlet; at least one inlet configured to be coupled to at least one pipeline of at least one pneumatic conveyance system; and at least one flexible barrier arranged inside the housing, configured to reduce the velocity of arrival of particles of material transported by the at least one pneumatic conveyance system from the at least one inlet to the outlet.

Optionally, the receiver device comprises at least one cartridge comprising the at least one flexible barrier.

Optionally, the housing comprises at least one opening for inserting or removing the at least one cartridge.

Optionally, the at least one flexible barrier is a curtain made of fabric, plastic, or rubber.

Optionally, the outlet corresponds to the lower part of the receiver device, the lower part being at least partially open, or the outlet corresponds to a wall opposite the at least one inlet, the opposite wall being at least partially open.

The present invention also relates to the use of the receiver device as defined above for damping the velocity of particles of material transported in a pneumatic conveyance system.

The present invention also relates to a tank for use in a pneumatic conveyance system comprising the receiver device as defined above.

### BRIEF DESCRIPTION OF THE DRAWINGS

FIG. 1 illustrates an exemplary embodiment of the receiver device according to the present invention.

FIG. 2 illustrates an example of the application of the receiver device of FIG. 1.

### DETAILED DESCRIPTION

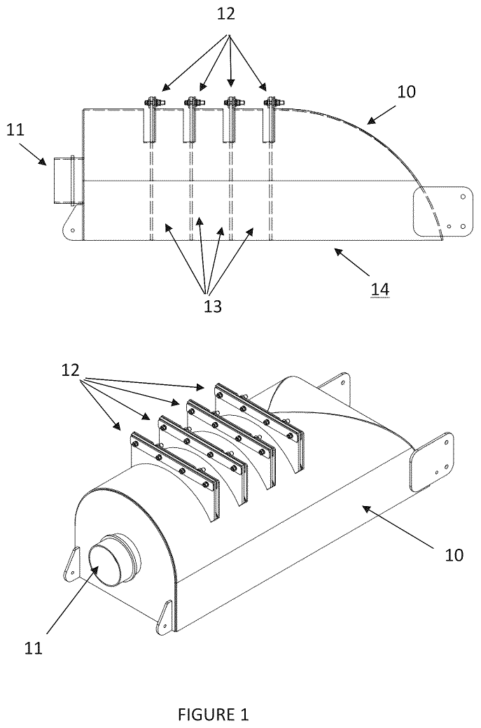

FIG. 1 illustrates an exemplary embodiment of the receiver device according to the present invention. The illustrated receiver device comprises a housing 10, an inlet 11, four cartridges 12, each containing a flexible barrier 13, and an outlet.

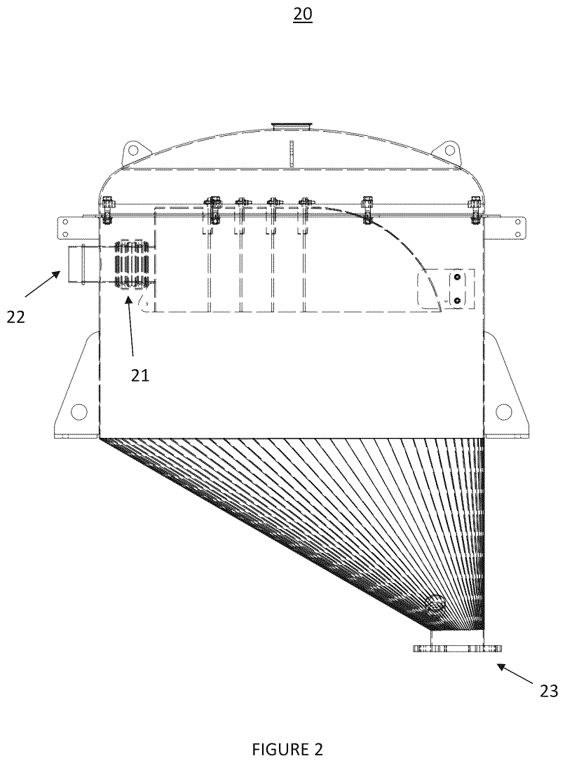

FIG. 2 illustrates an example of the application of the receiver device of FIG. 1 inside a receiving tank 20. The inlet 11 is connected to a pipeline 22 of a pneumatic system (not illustrated) through a coupling 21. As one skilled in the art will notice, any known method for connecting two pipes in the prior art can be applied as coupling 21.

The particles of material transported by the pneumatic conveyance system that arrive through pipeline 22 will pass through the inlet 11 and collide with the flexible barriers 13, which, due to their flexible nature, will bend, acting as a damping mechanism and reducing the arrival velocity of the particles. The reduction in arrival velocity and the effect of gravity will cause the particles to fall and accumulate inside tank 20. Tank 20 also has an outlet 23 at its lower part, which will allow the subsequent removal of the accumulated particles.

The outlet of the receiver device may correspond to the lower part 14 of the receiver device, which is preferably fully open. However, depending on the application, the lower part may be only partially open. For example, the opening at the lower part of the receiver device may correspond to the length of the arrangement of flexible barriers 13, being directly below this arrangement. Another example is providing an opening directly below the last flexible barrier 13, where, depending on the design, all or most of the transported material particles will stop.

Similarly, the receiver device does not necessarily need to be arranged horizontally. The receiver device can be arranged vertically or at any angle between horizontal and vertical axis. As a skilled person in the art will notice, depending on such an angle, the outlet of the receiver device may need to be relocated to the wall of the housing 10 opposite the inlet 11.

The housing 10 is made of rigid material, preferably metallic. The inlet 11 is an inlet capable of being coupled to a pipeline of a pneumatic conveyance system. Although a single inlet 11 has been illustrated, it should be understood that the receiver device may comprise any number of inlets depending on the number of pipelines and the complexity of the pneumatic conveyance system. For example, the receiver device may comprise two inlets connected to two pipelines from different pneumatic systems that converge into the same receiver device.

Likewise, although four flexible barriers 13 have been illustrated, it should be understood that at least one flexible barrier 13 must be present. The total number of flexible barriers 13 will depend on each design, such as the type of pneumatically transported material and the arrival velocities of the material at inlet 11. For example, a single flexible barrier 13 may be sufficient to reduce the entry velocity of transported material particles and minimize collisions.

In the illustrated embodiment, each cartridge 12 comprises one flexible barrier 13 and can be inserted and removed from the receiver device through upper openings in the housing 10. The upper part of the cartridge 12 can be made of rigid material and have a thickness corresponding to the thickness of the upper openings in the housing 10 to allow a press-fit connection.

However, any skilled person in the art will notice that the receiver device of the present invention could comprise the flexible barriers 13 arranged inside the receiver device and directly attached to the housing 10. The advantage of using cartridges 12 is to facilitate the removal/insertion of flexible barriers 13 for maintenance or replacement purposes.

Additionally, although cartridges 12 have been illustrated comprising a single flexible barrier 13, any skilled person in the art will recognize that it is possible to arrange cartridges 12 containing more than one flexible barrier 13.

As any skilled person in the art will also recognize, any material capable of acting as a damping mechanism can be used for the flexible barriers 13. Examples of flexible barriers 13 include curtains made of fabric, plastic, or rubber.

1. A receiver device, comprising:
a housing;
an outlet;
at least one inlet configured to be coupled to at least one pipeline of at least one pneumatic conveyance system and to receive particles of material transported by the at least one pneumatic conveyance system; and
at least one flexible barrier arranged inside the housing, configured to reduce the velocity of the particles of material from the at least one inlet to the outlet.

2. The receiver device of claim 1, comprising at least one cartridge comprising the at least one flexible barrier.

3. The receiver device of claim 2, wherein the housing comprises at least one opening for the insertion or removal of the at least one cartridge.

4. The receiver device of claim 1, wherein the at least one flexible barrier is a curtain made of fabric, plastic, or rubber.

5. The receiver device of claim 1, wherein:
the outlet corresponds to the lower part of the receiver device, the lower part being at least partially open; or
the outlet corresponds to a wall opposite the at least one inlet, the opposite wall being at least partially open.

6. A use of the receiver device of claim 1, for damping the velocity of particles of material transported in a pneumatic conveyance system.

7. A tank for use in a pneumatic conveyance system, comprising the receiver device of claim 1.
